(19) United States
(12) Patent Application Publication
(10) Pub. No.: US 2003/0120497 A1
(43) Pub. Date: Jun. 26, 2003

(54) System and method to facilitate the procurement of information from a user

(76) Inventors: Mario D'Amico, Laval (CA); Peter Zver, Pierrefonds (CA)

Correspondence Address: SMART & BIGGAR, Suite 3400, 1000 de la Gauchetiere Street West, Montreal, QC, H3B 4W5, CA

(21) Appl. No.: 10/024,266

(22) Filed: Dec. 21, 2001

(51) Int. Cl. G06F 17/60

(52) U.S. Cl. 705/1; 705/9

(57) ABSTRACT

A method to facilitate procurement of information from a user. The method includes delivering information to the user from a computer prompting the user to enter at the computer information identifying a project, prompting the user to perform at the computer an action to specify a billing-related information relating to the project and prompting the user to provide to the computer information associated to the project but unrelated to the billing-related information. When the above information is provided by the user, the method includes generating a first message including data identifying the project and data specifying the billing-relaed information, generating a second message including at least a portion of the information identifying the project and the information associated to the project but unrelated to the billing-related information, and sending the first message and the second message to different destinations. The invention also extends to a system implementing the above method.

### FIELD OF THE INVENTION

The invention relates to the art of information collection, in particular to a tool for allowing a user to supply information through a computer system using a billing related information logging event as a vehicle.

### BACKGROUND OF THE INVENTION

Professional knowledge workers in the service industry are often required, in addition to performing tasks related to projects, to manage information that is extraneous to their core activities, yet of some importance to the business. For example an attorney in a law firm, while conferring with a client on a certain matter may learn that the client needs legal services on an entirely different legal problem. In those circumstances, the firm normally expects the attorney to take the necessary steps to convey the information to the proper individual in the organization capable to address the other need of the client. In practice, the attorney will phone or e-mail that individual to convey the necessary information about the client. In many cases, however, the information is not communicated effectively which results in a loss of business.

Against this background, there exists a need in the industry to provide a novel method, a system and components of a system to facilitate the procurement of information from users, in particular professional knowledge workers.

### SUMMARY OF THE INVENTION

In a first broad aspect, the invention provides a computer-implemented method to facilitate procurement of information from a user. The method includes prompting the user at the computer to perform an action to specify billing-related information relating to a certain project, and also prompting the user to provide to the computer information associated to the project but unrelated to the billing related information.

Professional knowledge workers account for their services by periodically logging billing related information as their work progresses. When the work is completed, the billing related information log is used to create a statement of account. The method according to the present invention uses billing-related information logging events in connection with a project as a user-friendly vehicle to capture from the user information that is also associated to the project, but unrelated to billing.

Under a specific and non-limiting example of implementation, the method includes the step of delivering to the user from a computer information prompting the user to enter at the computer information identifying a project. In the case of visual information delivery, the information can be displayed to the user on a display device. The displayed information can be in the form of a graphical user interface (GUI) where the user is prompted actively or passively to enter the information identifying the project. Assists can be provided to facilitate the information entry. One such assist provides a list of previously entered project identifiers, allowing the user to select any one of those identifiers as input. Another example of an assist is a search engine. The user enters keywords that are used to search a database of project identifiers for matches.

The information identifying the project includes the identifier of a client. Optionally, the project identifier includes also a matter identifier. The matter identifier is useful in that it can differentiate between different tasks performed for the same client.

The billing-related information is information that can be used alone or in conjunction with other information to produce a statement of account. The billing-related information specified by the user can have one or more components. The time pertaining to the performance of a certain task is an example of such component. Another example is an expense or disbursement incurred for the performance of a task.

In a specific and non-limiting example, the step of prompting the user to provide to the computer information associated to a project but unrelated to billing can be done actively or passively, allowing the user to enter the desired information. Optionally, this step also includes providing to the user a destination selector where the user can specify the location at which the information will be directed.

In a specific and non-limiting example of implementation, the method includes processing the information entered by the user and generating two messages forwarded to different destinations. The first message includes data identifying the project and data specifying the billing-related information. The second message includes at least a portion of the information identifying the project and the information associated to the project but unrelated to billing. In a specific non-limiting example, the second message may be forwarded to a knowledge database for storage.

Optionally, the method further provides knowledge database access capabilities for retrieving billing-unrelated information previously stored in the database.

Any one of the steps that involves an interaction between the user and the computer is effected through an input device of the computer. Such input device includes one or more of the following: keyboard, pointing device, touch sensitive surface or speech recognition unit.

In a second broad aspect, the invention provides a computer readable storage medium containing a program element for execution by a CPU. The program element comprises a first program element component for causing a computer to display information to the user prompting the user to enter at the computer information identifying a project. A second program element component causes the computer to display information to the user, prompting the user to perform at the computer an action to specify billing-related information. A third program element component causes the computer to display third information to the user, prompting the user to provide to the computer information associated to the project but unrelated to billing.

The program element can be executed in the computer itself; hence the program instructions are executed by the CPU of the computer. Alternatively, the program element is executed by the CPU of a server machine that is in a network arrangement with the computer acting as a client machine.

In a third broad aspect, the invention provides a system to facilitate procurement of information from a user, comprising a computer and a computer readable storage medium containing a program element for execution by a CPU. The program element includes:

1. a first program element component for causing the computer to display first information to the user, the first information prompting the user to enter at said computer information identifying a project;

2. a second program element component for causing the computer to display second information to the user, prompting the user to perform at the computer an action to specify a billing-related information;

3. a third program element component for causing said computer to display third information to the user, prompting the user to provide to the computer information associated to the project but unrelated to billing.

### BRIEF DESCRIPTION OF THE DRAWINGS

A detailed description of examples of implementation of the present invention is provided hereinbelow with reference to the annexed drawings, in which:

FIG. 1 is a functional block diagram of the system to facilitate procurement of information from a user;

FIG. 2 is a block diagram of a computer used in the system shown in FIG. 1;

FIG. 3 is a diagrammatic representation of a GUI for communicating information to the user and for collecting information from the user; and

FIG. 4 is a block diagram of the architecture of a program element that controls the operation of the system to facilitate procurement of information from a user.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

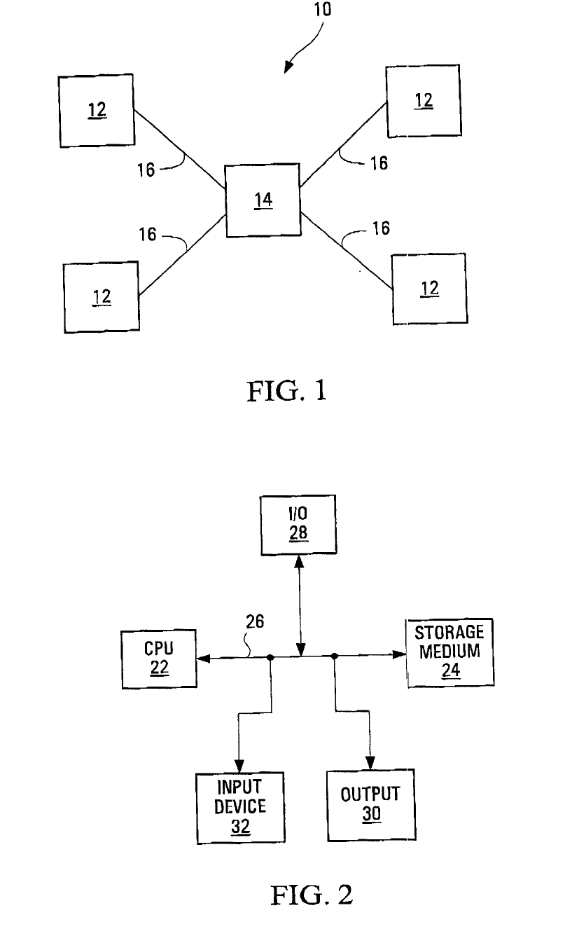

FIG. 1 illustrates a network-based system 10 for collecting information from a user. The system includes a plurality of client machines in the form of individual computers 12 connected to a server machine 14. The communication links 16 between the computers 12 and the server 14 can be metallic conductors, optical fibers or wireless, without departing from the spirit of the invention.

FIG. 2 is a block diagram of a computer 12. The computer 12 includes a Central Processing Unit (CPU) 22 connected to a storage medium 24 over a data bus 26. Although the storage medium 24 is shown as a single block, it may include a plurality of separate components, such as a floppy disk drive, a fixed disk and a Random Access Memory (RAM), among others. The computer 12 also includes an Input/Output (I/O) interface 28 that connects to the data bus 26. The I/O 28 is the entity through which the workstation 12 communicates with other entities of the system 10. For instance, data sent from or received by the computer 12 during a communication session with the server machine 14 or any other computer 12, transits through the I/O interface 28.

The computer 12 also includes an output device 30 to communicate information to a user. In the example shown, the output device 30 includes a display. Optionally, the output device 30 includes a loudspeaker. The computer 12 further includes an input device 32 through which a user at the computer 12 may input data. The input device 32 includes any one or a combination of the following: keyboard, pointing device, touch sensitive surface or speech recognition unit.

When the computer 12 is in use, the storage medium 24 holds software executed by the CPU 22 to implement a browser. It is through this browser that the user can receive information sent by the server machine 14 and it can, in turn, deliver information to the server machine 14. The communication between the computer 12 and the server machine 14 can be effected on the basis of any suitable protocol, such as HyperText Transfer Protocol (HTTP).

The structure of the server machine 14 is identical to the structure of the computer 12. The main difference resides in the software that is executed by the CPU 22 of the server machine 14 which gives the server machine 14 a different functionality than the functionality of the computer 12.

From a functional perspective, the program element executed by the CPU 22 of the serer machine 14 can be divided in several components. The components differ from one another primarily by the information they deliver, capture or process, not necessarily by the way the actual code is being organized.

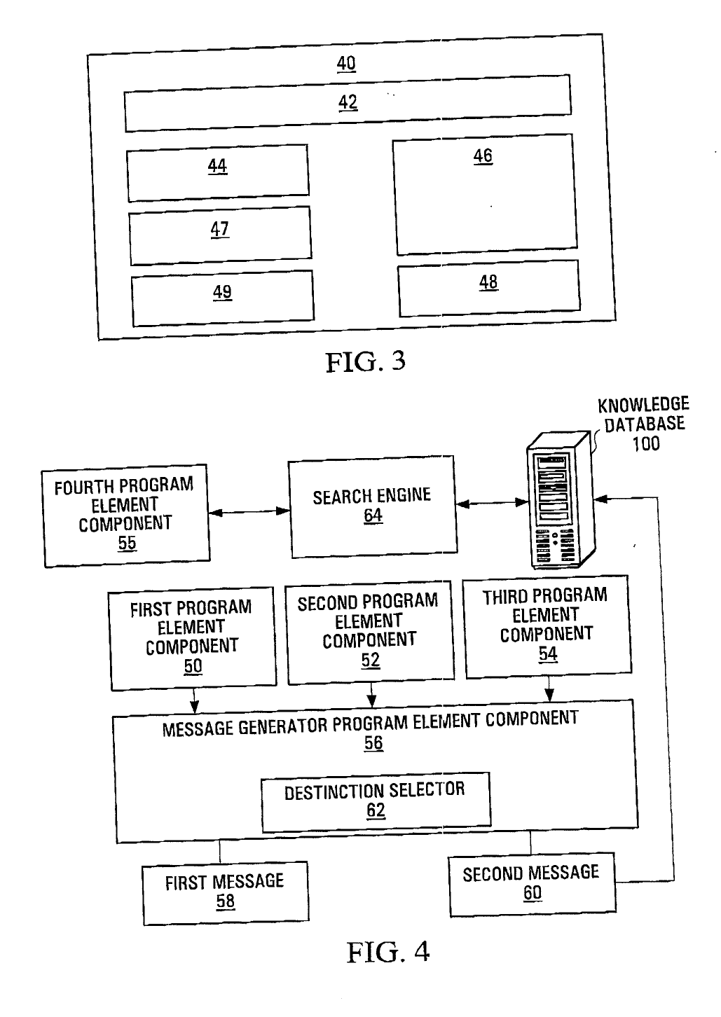

A block diagram of the architecture of the program element is shown in FIG. 4. A first program element component 50 prompts the user at the computer 12 to enter in the computer information identifying a project. In this example of implementation, the information is delivered to the user at computer 12 visually, through a GUI 40 shown at FIG. 3. The first program element component 50, executing on the server machine 14, sends messages to computer 12, over the communication link 16 between the server machine 14 and the computer 12. The browser on computer 12 uses those messages to present to the user information via the GUI 40. When information is to be sent from the computer 12 to the server machine 14, the browser on the computer 12 sends messages with the information over the communication link 16 to the server machine 14 that processes the information as required.

For the purpose of this specification, “message” should be interpreted in a broad sense and refers to the substance of the communication without any limitation as to the physical medium or protocol used to transmit the message.

The prompting can be active or passive. In the case of a passive prompting the user is presented with a control where information can be entered through the input device 32 of the computer 12. The active prompting includes, in addition to just presenting the control where the information can be entered, the performance of some other action positively urging he user to supply the information. One example is to present a dialog box with a message to draw the attention of the user, playing an audible message, among many others.

To facilitate the information entry by the user, assists can be provided. An example of such an assist is to present to the user a list of options for a selection. The list may include the last N project identifiers that were entered previously. Another example of an assist is a search engine that receives a keyword and searches a database of project identifiers to return all records matching the keyword. The user can then make a selection among the list of matches.

The project identifier includes information that designates the client for which a task is being performed. This information can be the client name, a code distinguishing this client from other clients, etc. Optionally, the project identifier includes a matter identifier. This option allows distinguishing between different tasks performed for the same client. Evidently, the project identifier can include additional information without departing from the spirit of the invention.

The user supplies the project identifier through the input device 32.

The program element executed by the CPU 22 of the server machine 14 includes a second program element component 52 for delivering information to the user from the computer 12, prompting the user to perform at the computer 12 an action to specify billing-related information. The prompting can be active or passive, with or without assists. The user performs the requested action at the input device 32. One example of billing-related information is the time pertaining to the performance of a task relating to the project. Under this example, the action may include entering a time interval on any suitable control 44 or starting/stopping a virtual clock (not shown in the drawings), among other possibilities. Another example of billing-related information is a expense or disbursement incurred during the performance of the task.

As in the case with the first program element 50, the exchange of information between the user at the computer 12 and the server machine 14 is done by the transmittal of messages over the communication link between the server machine 14 and the computer 12.

The program element executed by the CPU 22 of the server machine 14 includes a third program element component 54 for delivering information to the user from the computer 12, prompting the user to provide to the computer information associated to the project but unrelated to billing. The prompting can be active or passive, with or without assists. The user provides the necessary information at the input device 32. For example, the user can supply the information through the input device 32 at a control 46.

Information unrelated to billing is information that will not be used during the generation of the statement of account. In the way of non-limiting examples, the information can be related to marketing, business development, contacts, project notes or to an order process.

As with the first and second program element components 50 and 52, the third program element component 54 exchanges information with the user at the computer 12 by sending and receiving messages over the communication link 16 between the computer 12 and the server machine 14.

The program element executed by the CPU 22 of the server machine 14 further includes a message generator program element component 56 that receives from the first, second and third program element components 50, 52 and 54 the information entered by the user, generates at least two messages 58 and 60 and sends those messages 58 and 60 to at least two different destinations The first message includes data identifying the project and data specifying billing-related information. In a typical example, the first message is directed to a database that holds billable time information and expense information from which debit notes to clients can be generated. The second message includes it least a portion of the information identifying the project and the information associated to the project but unrelated to billing. The second message is sent to a destination that is different from the destination of the first message. Note that the two destinations are different not necessarily in the physical sense but in the ultimate purpose for which the information contained in each message is intended. While the information in the first message is used for billing purposes, the information in the second message will not be used for the same purpose.

The destination of the first message will usually be predetermined and the user has no control as to where this message goes. Optionally, the message generator program element component 56 provides the user with a selector, in the form of suitable controls on the GUI 40 to specify a destination for the first message. The destination of the second message can also be predetermined. For example, such destination is a knowledge database 100. In a multi-user environment, where multiple users input information unrelated to billing at respective computers 12, under the control of a common server 14, it is advantageous to configure the system such that the information unrelated to billing from every user is collected in the common knowledge database 100. Physically, the knowledge database may reside in the server 14, any one of the computers 12 or it may be of distributed nature and spread over several network entities.

In a further non-limiting example the second message can be issued to an electronic mail server adapted to deliver the information to an appropriate address.

Advantageously, the message generator program element component 56 includes a destination selector program element component 62 that allows the user to select a destination for the second message. The destination selector program element component 62 may also allow the user to specify an information category to which the information in the second message belongs. This is advantageous when the second message is directed toward the knowledge database 100. In a specific example of implementation, the destination selector 62 is accessible to the user in the form of a control 48 on the GUI 40 that offers the user a list of predetermined destination choices.

The destinations for the first message and the second message may be internal to the server 14 or external to the server 14. In the case of external destinations, the server 14 sends the messages, over any one of the communication links to the network entities that correspond to the respective destinations.

The program element executed by the CPU 22 of the server machine optionally includes a fourth program element component 55 that assists the user in searching the knowledge database 100 through the GUI 40. To that effect, the fourth program element causes the computer 12 to displays information to the user and prompting the user to provide through a suitable control 47 a search criteria, such as keywords, for searching the knowledge database 100. The control 47 interacts with a search engine 64 adapted to search the knowledge database 100 for records matching the search criteria. Once these records are found, a message comprising this information is sent back to the fourth program 55 element which presents the information to the user through a suitable control 49 of GUI 40.

As mentioned herein above, the exchanges of information between the user at computer 12 and the server machine 14 is done by the transmittal of messages over the communication link between the server machine 14 and the computer 12. Also, as with the first, second and third program element components 50, 52 and 54, the fourth and fifth program element components 55 and 57 exchange information with the user at the computer 12 by sending and receiving messages over a communication link 16 between the computer 12 and the server machine 14.

As with the first, second and third program element components 50, 52 and 54, the fourth program element component 55 exchanges information with the user at the computer 12 by sending and receiving messages over the communication link 16 between the computer 12 and the server machine 14.

In one possible variant, the invention can be implemented on a stand-alone computer rather than on a network based system. In this variant, the first program element component 50, the second program element component 52, the third program element component 54 and the fourth program element component 55, the message generator program element component 56, the search engine 64 and the knowledge database 100 reside locally in the storage medium of the computer and they are executed by the CPU 22 of the computer 12 to interface with the user.

Although various embodiments have been illustrated, this was for the purpose of describing, but not limiting, the invention. Various modifications will become apparent to those skilled in the art and are within the scope of this invention, which is defined more particularly by the attached claims.

1) A method to facilitate procurement of information from a user operating a computer, comprising:
a) delivering information to the user from the computer prompting the user to enter at the computer information identifying a project;
b) delivering information to the user from the computer prompting the user to perform at the computer an action to specify a billing-related information relating to the project;
c) delivering information to the user from the computer prompting the user to provide to the computer information associated to the project but unrelated to the billing-related information.

2) A method as defined in claim 1, wherein in response to the user
i) providing information identifying the project;
ii) performing the action to specify the billing-related information; and
iii) providing information associated to the project but unrelated to the billing-related information, the method further comprises:
(1) generating a first message including data identifying the project and data specifying the billing-related information;
(2) generating a second message including at least a portion of the information identifying the project and the information associated to the project but unrelated to the billing-related information; and
(3) sending the first message and the second message to different destinations.

3) A method as defined in claim 2, wherein the delivering of information to the user from the computer prompting the user to enter at the computer information identifying a project is done by displaying information on a screen.

4) A method as defined in claim 3, wherein the delivering of information to the user from the computer prompting the user to perform at the computer an action to specify a billing-related information relating to the project is done by displaying information on the screen.

5) A method as defined in claim 4, wherein the delivering of information to the user from the computer prompting the user to provide to the computer information associated to the project but unrelated to the billing-related information is done by displaying information on the screen.

6) A method as defined in claim 5 wherein the information identifying the project includes an identifier of a client.

7) A method as defined in claim 6, wherein the information identifying the project includes a matter identifier.

8) A method as defined in claim 6, wherein the user provides the information identifying the project through an input device selected in the group consisting of keyboard, pointing device, touch sensitive surface and speech recognition unit.

9) A method as defined in claim 8, wherein the billing-related information includes information selected from the group consisting of time information and expense information.

10) A method as defined in claim 8, wherein the billing-related information includes time information and wherein the action performed at the computer by the user to specify the time information includes entering through the input device a time interval.

11) A method as defined in claim 8, wherein the billing-related information includes time information and wherein the action performed at the computer by the user to specify the time information includes starting and stopping a clock through the input device.

12) A method as defined in claim 7, wherein the providing of information associated to the project but unrelated to the billing-related information is done through the input device.

13) A method as defined in claim 1, wherein the information unrelated to the billing-related information is selected in the group consisting of marketing information, business development information, information regarding contact, project notes and information relating to an order process.

14) A method as defined in claim 2, wherein the second message is sent to a knowledge database.

15) A method as defined in claim 14, further comprising:
a) delivering information to the user from the computer prompting the user to enter at the computer search criteria for searching the knowledge database;
b) searching the knowledge database on the basis of the search criteria to derive matching information;
c) delivering the matching information to the user with the computer.

16) A computer readable storage medium containing a program element for execution by a CPU, said program element comprising:
a) a first program element component for causing a computer to display first information to the user, the first information prompting the user to enter at a computer information identifying a project;
b) a second program element component for causing the computer to display second information to the user, prompting the user to perform at the computer an action to specify billing-related information relating to the project;
c) a third program element component for causing the computer to display third information to the user, prompting the user to provide to the computer information associated to the project but unrelated to the billing-related information.

17) A computer readable storage medium as defined in claim 16, wherein said program element further comprises a message generator program element component responsive to data representative of information identifying the project, data representative of the billing-related information and data representative of information associated to the project but unrelated to the billing-related information, for:
i) generating a first message including data identifying the project and data specifying the billing-related information;
ii) generating a second message including at least a portion of the information identifying the project and the information associated to the project but unrelated to the billing-related information;
iii) sending the first and the second message to different destinations.

18) A computer readable storage medium as defined in claim 17, wherein the CPU resides on a server machine and the computer is a client machine in a network arrangement with the server machine.

19) A computer readable storage medium as defined in claim 17, wherein the computer is a client machine in a network arrangement with a server machine and wherein the CPU resides in the computer.

20) A computer readable storage medium as defined in claim 18, wherein the first, second and third program element components generate control messages to the client machine to cause the client machine to display the first, second and third information to the user.

21) A computer readable storage medium as defined in claim 18, wherein the control messages are HTTP messages and the client machine displays the first, second and third information to the user through a browser.

22) A computer readable storage medium as defined in claim 21 wherein the information identifying the project includes an identifier of a client.

23) A computer readable storage medium as defined in claim 20, wherein the information identifying the project includes a matter identifier.

24) A computer readable storage medium as defined in claim 17, wherein said program element includes a destination selector program element component for causing the computer to display fourth information to the user for allowing the user to select a destination for the second message.

25) A computer readable storage medium as defined in claim 16, wherein the billing-related information includes information selected from the group consisting of time information and expense information.

26) A computer readable storage medium as defined in claim 16, wherein the billing-related information includes time information and wherein the action performed at the computer by the user to specify the time information includes entering through the input device a time interval.

27) A computer readable storage medium as defined in claim 16, wherein the billing-related information includes time information and wherein the action performed at the computer by the user to specify the time information includes starting and stopping a clock through the input device.

28) A computer readable storage medium as defined in claim 17, wherein said message generator program element component directs the second message to a knowledge database.

29) A computer readable storage medium as defined in claim 28, wherein said program element further comprises a fourth program element component for causing the computer to display fourth information to the user and prompting the user to provide to the computer a search criteria for searching the knowledge database.

30) A computer readable storage medium as defined in claim 29, wherein said program element includes a search engine to search the knowledge database on the basis of the search criteria to generate matching information.

31) A computer readable storage medium as defined in claim 30, wherein said fourth program element component causes the computer to display the matching information to the user.

32) A computer readable storage medium as defined in claim 12, wherein the information unrelated to the billing-related information is selected in the group consisting of marketing information, business development information, information regarding contact, project notes and information relating to an order process.

33) A system to facilitate procurement of information from a user, comprising:
a) a computer;
b) a computer readable storage medium containing a program element for execution by a CPU, said program element including:
i) a first program element component for causing said computer to display first information to the user, the first information prompting the user to enter at said computer information identifying a project;
ii) a second program element component for causing said computer to display second information to the user, prompting the user to perform at said computer an action to specify a billing-related information;
iii) a third program element component for causing said computer to display third information to the user, prompting the user to provide to said computer information associated to the project but unrelated to the billing-related information.

34) A system as defined in claim 33, wherein said program element includes a message generator program element component responsive to data representative of information identifying the project, data representative of billing-related information and data representative of information associated to the project but unrelated to the billing-related information, for:
i) generating a first message including data identifying the project and data specifying billing-related information;
ii) generating a second message including at least a portion of the information identifying the project and data specifying information associated to the project but unrelated to the billing-related information;
iii) sending the first message and the second message to different destinations.

35) A system as defined in claim 34, comprising a server machine, said computer readable storage medium being located in said server machine, said server machine including a CPU for executing said program element.

36) A system as defined in claim 35, wherein said computer constitutes a client machine, said client machine being in a network arrangement with said server machine.

37) A system as defined in claim 36, wherein said client machine is operative to run a browser.

38) A system as defined in claim 37, wherein said first, second and third program element components send messages with said browser and cause said browser to display said first, second and third information to the user.

39) A system as defined in claim 37, wherein the billing-related information includes information selected from the group consisting of time information and expense information.

40) A system as defined in claim 37, wherein the billing-related information includes time information and wherein the action performed at the computer by the user to specify the time information includes entering through the input device a time interval.

41) A system as defined in claim 37, wherein the billing-related information includes time information and wherein the action performed at the computer by the user to specify the time information includes starting and stopping a clock through the input device.

42) A system as defined in claim 34, wherein said message generator program element component directs the second message to a knowledge database.

43) A system as defined in claim 42, wherein said program element further comprises a fourth program element component for causing the computer to display fourth information to the user, prompting the user to provide to the computer a search criteria for searching the knowledge database.

44) A system as defined in claim 43, wherein said program element includes a search engine to search the knowledge database on the basis of the search criteria to generate matching information.

45) A system as defined in claim 44, wherein said fourth program element component causes the computer to display the matching information to the user.

46) A system as defined in claim 33, wherein the information unrelated to the billing-related information is selected in the group consisting of marketing information, business development information, information regarding contact, project notes and information relating to an order process.
